(19) United States
(12) Patent Application Publication
(10) Pub. No.: US 2014/0316936 A1
(43) Pub. Date: Oct. 23, 2014

(54) TAX CODE DETERMINATION

(71) Applicant: INTERNATIONAL BUSINESS MACHINES CORPORATION, Armonk, NY (US)

(72) Inventors: K. Susan G. Champlain, Corning, NY (US); Andrew Coleman, Vestal, NY (US); James R. Crossgrove, Owego, NY (US); Nitin Jhingan, Vestal, NY (US); Michele A. Roach, Endicott, NY (US)

(73) Assignee: International Business Machines Corporation, Armonk, NY (US)

(21) Appl. No.: 13/867,654

(22) Filed: Apr. 22, 2013

(51) Int. Cl. G06Q 40/00; G06Q 30/06

(52) U.S. Cl. CPC G06Q 40/10; G06Q 30/0633
USPC 705/26.8

(57) ABSTRACT

A method of assigning tax codes for a transactional document such as a list of items in a shopping cart. This method is a configurable solution without making changes to the application code. A series of questions are directed to an end user. Depending on the tax requirements of a country, the questions are tailored in a language understandable to the user. From these questions, possible answers are collected, and translated to a set of indicators. These indicators are mapped to tax codes that can be assigned to a transactional document listed in a shopping cart.

### BACKGROUND OF THE INVENTION

### Field of the Invention

The invention relates to tax code assignments to a transactional document. More specifically, the invention relates to a configurable solution for assigning tax codes without making changes to application code.

### BRIEF SUMMARY OF THE INVENTION

As explained in U.S. Pat. No. 5,819,249, Dohanich describes an expert system that includes a database, an expert knowledge interface and an inference engine to an accounting system for tax coding. The inference engine drives the user interface and receives user responses in which the system will then determine the applicable tax coding.

In U.S. Pat. No. 7,386,495, Cirulli describes a method of assigning taxability codes to purchases and processing tax invoices by company group. A user inputs a requisition in a front end system. The tax code and tax location are identified and converted into an applicable tax code and tax jurisdiction. A back end processor creates a purchase order based on the converted tax code and tax jurisdiction for the company group. The purchase order is transmitted to a supplier and supplier invoices. Invoice is received and processed, in back end system, based on the taxability.

In U.S. Pat. No. 7,739,160, Ryan describes a computer implemented method for determining tax data associated with a transaction (including invoices, purchase orders) using singularly defined rules. Data associated with a transaction is received and a taxable consequence is determined based on a jurisdiction code and a product code.

In U.S. Pat. No. 8,150,736, Horn describes a Global Store that provides buyers with adequate information to make buying decisions. An open-frame interactive shopping cart asks the buyer to answer specific questions that appear before the buyer proceeds to checkout or returns to shopping. The Global Store application script operates in conjunction with an external tax computing service to collect any taxes that may be due for the purchase of a product.

In 2011/0246318, Coulter describes a tax service adapted to automatically calculate tax and apportionment based on location of user, location of merchant, taxable rates, product type, and/or various other characteristics that may affect overall taxation for network based financial transactions in the tax process.

The above U.S. Patents by Dohanich, Cirulli, Ryan, Horn, and Coulter shall be incorporated herein by reference in their entireties.

### BRIEF DESCRIPTION OF THE SEVERAL VIEWS OF THE DRAWINGS

FIG. 1 is a flow chart illustrating the basic operational steps of an embodiment of the present invention; and

FIG. 2 is a system of a computer hardware and software product for use in implementing portions of the present invention.

### DETAILED DESCRIPTION OF THE INVENTION

For a better understanding of the present invention, together with other and further objects, advantages, and capabilities thereof, reference is made to the following disclosure and the appended claims in connection with the above-described drawings.

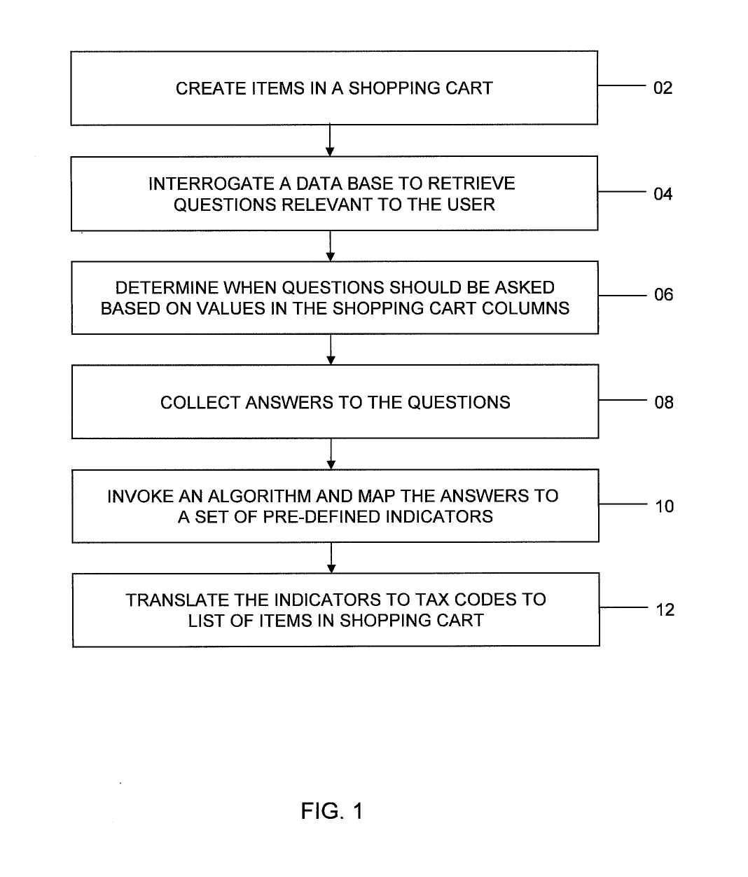

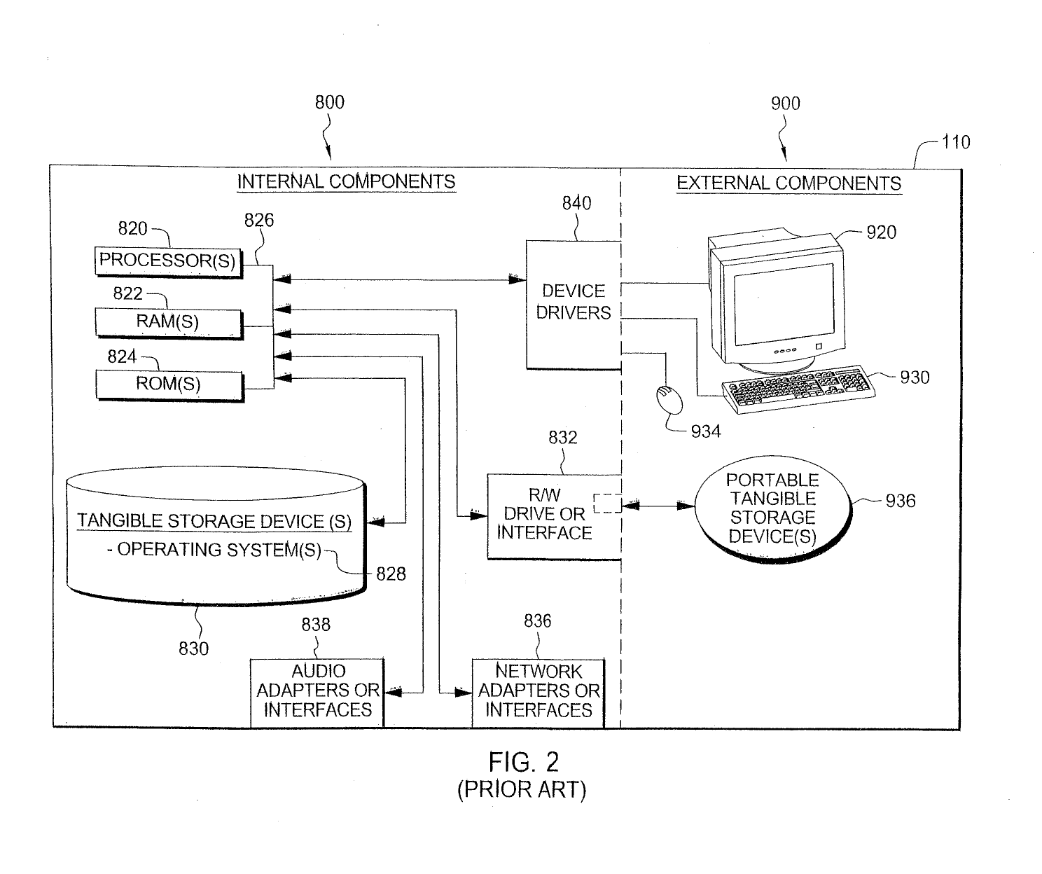

In FIG. 1, there is shown a flowchart depicting steps performed in practicing one embodiment of the invention. In step 02, a user logs on to a front end requisitioning tool tied to a computer such as described in FIG. 2 used to create items in a shopping cart used for purchase. The items in the shopping cart are the transactional document.

In step 04, sales taxability needs to be determined for items in the shopping cart. To determine this taxability, questions are asked to user. The questions are configured in a language understandable to the user. A database table is interrogated to obtain the questions and possible answers. This database table contains previously stored questions and possible answers and next actions.

In step 06, the system determines when the questions should be asked. The term “when” shall be taken herein to have the broad meaning of under what circumstances or considerations. For example, a user from the United States may see different questions than a user from Canada. The difference may be due to the different tax requirements in the two countries, or for any other reason. An ordered list of column names determines which of the shopping cart table columns are used to look for questions. If those columns are configured to determine the key, the values for items in the shopping cart would be connected together to create a key used to look for question. This enables questions to be configured for any values in any columns in the shopping cart table. The key may consist of words and numbers. As an example, a shopping cart with country ‘US’ and company ‘0001’ would look for questions with key ‘US˜0001’.

In step 08, during checkout of the shopping cart, the system constructs keys and searches for configured questions. If a question is found, it is displayed to the user along with possible answers. When the user selects an answer, the system determines what to do next based on the answer. Some questions are answered by having an algorithm associated with the questions. The question sequence may be determined by a combination of user input and transactional data. The use of transactional data could shorten the sequence of questions presented to the user. While other systems require the user to have knowledge to pick the correct tax code, the present invention provides a question sequence that allows the system to assign the tax code without requiring the user to know the correct tax code. A list of questions asked, and the answers selected, are stored for the shopping cart.

In step 10, when the final question is answered, an algorithm is involved and sets the indicators to a pre-defined, configurable value. For example, the indicators may be tax jurisdiction codes that are derived from the delivery address of the items in the shopping cart.

In step 12, the indicators are sent to a back end tool, such as an ERP system tied to a computer such as described in FIG. 2, that translates the indicators to tax codes. ERP acronym stands for Enterprise Resource Planning which is part of SAP GMBH. SAP acronym means Systems, Applications Products which is a software company. Other ERP systems which are not part of SAP may also be used. The algorithms associated with the questions can define codes which can be interpreted by different ERP's, not just SAP. These tax codes are assigned to a transactional document, listed in a shopping cart.

Another advantage of the present invention applies where the set of physical delivery addresses is not known ahead of time, so that all of the configuration cannot be created before the transaction is processed. The present invention allows for a question sequence, where the delivery address can be examined by the system, and a question sequence presented to the user so that the relevant tax-related characteristics of that delivery address can by dynamically determined. Then those characteristics can be used to generate the tax code.

FIG. 2, shows a block diagram of internal components 800 and external components 900 of a computer 110, in accordance with an illustrative embodiment of the present invention. It should be appreciated that FIG. 2 provides only an illustration of one implementation and does not imply any limitations with regard to the environments in which different embodiments may be implemented. Many modifications to the depicted environments may be made based on design and implementation requirements.

Computer 110 is representative of any electronic device capable of executing machine-readable program instructions. Computer 110 may be representative of a computer system or other electronic devices. Examples of computing systems, environments, and/or configurations that may be represented by computer 110 include, but are not limited to, personal computer systems, server computer systems, thin clients, thick clients, laptop devices, smart phones, multiprocessor systems, microprocessor-based systems, network PCs, minicomputer systems, and distributed cloud computing environments that include any of the above systems or devices.

Computer 110 includes a set of internal components 800 and external components 900. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, functions in computer device 110 are stored on one or more of the respective computer-readable tangible storage devices 830 for execution by one or more of the respective processors 820 via one or more of the respective RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. Functions in computer 110 can be stored on one or more of the respective portable computer-readable tangible storage devices 936, read via the respective R/W drive or interface 832 and loaded into the respective hard drive 830.

Internal components 800 also includes audio adapters or interfaces 838 such as a sound card, hardware mixer, amplifier, or other adapters or interfaces for receiving audio signals from microphones.

Internal components 800 also includes network adapters or interfaces 836 such as a TCP/IP adapter cards, wireless wi-fi interface cards, or 3G or 4G wireless interface cards or other wired or wireless communication links. Functions in computer 110 can be downloaded to computer 110 from an external computer via a network (for example, the Internet, Cloud 24, a local area network or other, wide area network) and respective network adapters or interfaces 836. From the network adapters or interfaces 836. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention as defined by the appended claims.

What is claimed is:

1. A method of assigning tax codes for a transactional document, listed in a shopping cart comprising the steps of:
storing in a database questions and a list of possible answers for each of said questions, and a next action to take for each of the answers;
determining when said questions should be asked;
during checkout of said document, if one or more of said questions are found, displaying to a user, the found question along with said possible answers;
receiving a answer selection from said user, performing the next action and storing a list of questions asked and answers selected for said document;
mapping said answers selected to predefined indicators and mapping said indicators to tax codes; and
assigning the mapped tax codes to said document.

2. The method of claim 1,
wherein said transactional document is list of items in a shopping cart or purchase order.

3. The method of claim 1, wherein said questions stored in said database are based on tax requirements of a specific country.

4. The method of claim 1, wherein said questions are in a language known by said user.

5. The method of claim 2, wherein column names determine what said list of items in shopping cart table column to refer to, to obtain said questions

6. The method of claim 4, wherein said questions and said possible answers displayed to said user, are configured in said language.

7. The method of claim 2, further comprising step of answering a question by having an algorithm associated with said question.

8. The method of claim 2, wherein the data obtained from said questions and said answers, are stored in said list of items in said shopping cart.

9. The method of claim 7, wherein said algorithm sets said indicators to pre-defined values to map said tax codes to said list of items in said shopping cart or said purchase order.

10. A system for assigning tax codes for a transactional document, listed in a shopping cart comprising:
a front end user requisition tool;
a database table, within said user requisition tool, that tailors question questions to user;
said database table, collects answers to said questions and translates the answers to a set of pre-defined indicators;
said indicators are routed, via an interface within said user requisition tool, to a backend tool; and
said back end tool, translates said answers and maps tax codes to said transactional document.

11. The system of claim 10, wherein the system allows a user to create said items for a shopping cart.

12. The system of claim 10, wherein the system will configure questions specific to a country's tax requirements.

13. The system of claim 10, wherein the system determines said questions asked based on the table columns on a shopping cart.

14. The system of claim 10, wherein the system will capture and record said answers.

15. The system of claim 10, wherein the tool is a ERP system component of SAP that determines tax codes to assign to said items in a shopping cart.

16. A computer program product for a method of assigning tax codes for a transactional document, listed in a shopping cart said computer program product comprising:
a computer readable storage medium;
first program instructions in front end process for receiving from a user items created for a shopping cart;
second program instructions for interrogating a database for list of questions relevant to user;
third program product for determining when questions should be asked based on table columns in shopping cart table;
fourth program instructions for searching for questions and collecting answers to said questions;
fifth program instructions for invoking an algorithm for mapping answers to a set of pre-defined indicators;
sixth program instructions in back end process translates indicators and assigns tax codes to items in shopping cart; and wherein;
all said program instructions means are recorded on said medium.
